(19) United States
(12) Patent Application Publication
(10) Pub. No.: US 2004/0213542 A1
(43) Pub. Date: Oct. 28, 2004

(54) Apparatus and method to reproduce multimedia content for a multitude of resolution displays

(76) Inventors: Hiroshi Hamasaka, Osaka (JP); Masayuki Kozuka, (US); Masataka Minami, Arcadia, CA (US)

Correspondence Address: SNELL & WILMER L.L.P., Attention: Joseph W. Price, Esq., 1920 Main Street, Suite 1200, Irvine, CA, 92614-7230, US

(21) Appl. No.: 10/420,426

(22) Filed: Apr. 22, 2003

(51) Int. Cl. H04N 5/781

(52) U.S. Cl. 386/46; 386/126

(57) ABSTRACT

An apparatus and method for reproducing character-based content at a multitude of possible resolutions without distortion. The character-based content is read from a storage medium at a stored resolution format and is converted to a desired resolution format for display on an attached display device. The reproduction apparatus can compute a ratio between the desired display resolution and the stored resolution to convert the character-based content into the desired resolution format, wherein the computed ratio more particularly includes both a horizontal conversion ratio and a vertical conversion ratio. The line height of the converted character-based content may further be adjusted to ensure a square pixel resolution of the converted content being reproduced in order to ensure that the converted content is not distorted. The reproduction apparatus can detect whether the content includes a resolution value and if a resolution value is not present, a default resolution value can be substituted. A storage medium can be encoded with designated control information to enable a detection of a resolution value to enable the reproduction apparatus. The reproduction apparatus can have a complementary capability to substitute a resolution value if the designated control information is not detected.

### BACKGROUND OF THE INVENTION

1. Field of the Invention

This invention relates to an apparatus and method for receiving data to be displayed on a display device and reproducing the data for display according to a resolution of the display device. More particularly, the present invention relates to an apparatus and method for reproducing multimedia content in an undistorted manner for a variety of possible resolutions.

2. Description of Related Art

The introduction of high definition television (HDTV) has generated a large amount of publicity because of the superior performance characteristics of HDTV compared to that of standard definition television (SDTV). HDTV offers approximately twice the vertical and horizontal resolution of standard definition television (SDTV), where the resolution of a HDTV is typically 1920 by 1080 pixels as compared to the typical SDTV resolution of 720 by 480 pixels. In the United States, the Advanced Television System Committee (ATSC) standard defines digital video encoding of high definition (HDTV) signals. A portion of this standard is essentially the same as the MPEG-2 standard, proposed by the Moving Picture Experts Group (MPEG) of the International Organization for Standardization (ISO). The MPEG-2 standard is actually several different standards. Several different profiles are defined within MPEG-2, each corresponding to a different level of complexity of the encoded image. For each profile, different levels are defined, each level corresponding to a different image resolution. One of the MPEG-2 standards, known as Main Profile, Main Level is intended for coding standard definition (SD) images having a resolution for display on a SDTV. Another standard, known as Main Profile, High Level is intended for coding high definition (HD) images having a resolution for display on a HDTV.

Due to the larger amount of information contained within a high definition (HD) image as compared to a standard definition (SD) image, HDTV images are encoded using a different video coding standard than SDTV images. Thus, most SDTV displays cannot decode an image encoded using an HDTV video coding format and vice versa. Despite the superior performance that HDTV provides over SDTV, a major obstacle preventing widespread usage of HDTV has involved how to implement HDTV while continuing to support the large number of existing SDTV display devices already in use.

The relatively high cost of HDTV display devices makes immediately replacing existing SDTV display devices with HDTV display devices impractical. Moreover, since SDTV display devices still account for the larger majority of the display devices in use, nearly all content is currently provided for viewing in SDTV format. Thus, a widespread implementation of HDTV must address the problem of how to support the existing SDTV display devices currently in use for information provided in HDTV format as well as how to support the new HDTV display devices for the information currently provided in SDTV format. Furthermore, multimedia devices like optical disc players need to support both HDTVs as well as SDTVs.

One possible solution is to provide content in both formats to a set top box capable of decoding both formats. This causes problems in the broadcast environment, due the limited availability of distribution bandwidth. Furthermore, most commercially available storage mediums, such as DVDs, do not possess the storage capability to store content in both HDTV format and SDTV format, especially in view of the large amount of information contained in HDTV images. An alternate solution is to provide a format converter which converts either standard definition (SD) content to high definition content (HD) or HD content to SD content, depending upon the resolution of the attached display device. This type of format decoder can be sold separately as a stand-alone unit that can be attached to a display device, such as a set top box, optical disc player, or the like. Alternatively, many HDTV manufacturers are currently incorporating format decoders within the television itself to perform this conversion.

Although a format decoder allows new HDTV displays to take advantage of the new HDTV technology while allowing existing SDTV displays to continue to be used, these format decoders possess deficiencies in the quality of the content which is converted from one display format to the other and reproduced. Such deficiencies are particularly noticeable when converting character-based content, such as text appearing HTML data. The display of character-based information has become increasingly widespread with the gaining popularity of DVDs, where the increased storage capacity of DVDs has allowed a great variety of content to be stored thereon in addition to the video content to be displayed. For instance, video content stored on a DVD may have associated therewith multilingual video titles, sub-titles, or on-screen display. Here, the expression “multilingual” refers to a user being able to select characters from one out of a plurality of languages which are then reproduced with the moving picture information. As one example, a multilingual video title aimed at the U.S. and European markets can include separate dubbing soundtracks and sub-picture information for English subtitles, German subtitles, French subtitles, and Spanish subtitles, so that users can watch a movie in their specified language.

This multimedia content is encoded and stored on DVDs or other storage mediums according to a particular display resolution, most typically content is encoded having SD resolution for display on a SDTV. However, such character-based content must be converted to another resolution when the display device possesses a different resolution than the resolution of the stored character-based content. In the situation where an optical disc player is attempting to reproduce an image encoded in a high-resolution (HD format) for display on a SDTV, the whole display image must be down-converted to a SD format. If the conversion from HD to SD is done on the video signal level, such as by utilizing simple interpolation, the resulting quality of the image can be miserable. This can cause particular characters and fonts to become quite difficult to read. If simple interpolation is not utilized, the device for the interpolation will be very expensive due to the need for the device to process an extremely large amount of HD data in real-time. Furthermore, in the situation where an optical disc player is reproducing an image encoded in a standard-resolution (SD format) for display on an HDTV, the whole display image must be up-converted which can make the displayed characters appear rugged or distorted. Consumers who purchase HDTVs expect a high definition display having a superior presentation to that of SDTVs, thus rendering the rugged or distorted display of character-based data quite unacceptable.

### SUMMARY OF THE INVENTION

The present invention provides an apparatus and method for reproducing multimedia content at a multitude of possible resolutions without distortion. The preferred embodiment of the present invention is directed to reproducing multimedia content which is received or read from a storage medium at a stored resolution format and is converted to a desired resolution format for display on an attached display device. The reproduction apparatus of the present invention utilizes a computed ratio between the desired display resolution and the stored resolution to convert the multimedia content into the desired resolution format. The computed ratio more particularly includes both a horizontal conversion ratio and a vertical conversion ratio which respectively represent the number of horizontal and vertical pixels in the desired display resolution to the number in the stored resolution. The horizontal and vertical conversion ratios are utilized to convert and resize the character-based content to the desired display resolution. In an alternative embodiment of the present invention, the line height of the converted multimedia content may further be adjusted to ensure a square pixel resolution of the converted content being reproduced.

The reproduction apparatus could further be provided with default values, including default values different from a specific disc type. Such a default value could be set to a conventional resolution or a high-resolution based upon the particular media or disc type detected by the reproduction apparatus.

The reproduction apparatus can reproduce encoded data so that the encoded data is compatible for display on display devices having different resolution capabilities, the encoded data may include a plurality of objects, the objects further comprising motion picture data, sub-picture data and control data. The control data includes information on the resolution of the motion picture data.

The reproduction apparatus includes a reading unit for inputting the encoded data, a first memory unit for storing first resolution data information for a display device operatively connected to the reproduction apparatus and to be enabled to display objects from the reproduction apparatus; and a second memory unit for storing second resolution data information on the encoded data read by the reading unit.

A converting unit can convert the encoded data read by the reading unit into a second data format having a compatible display resolution for the resolution data information stored in the first memory unit and a controller unit can compare the first resolution data information with the second resolution data information and (1) when the first resolution data information and the second resolution data information indicate a functional compatibility, the reproduction apparatus can proceed to decode and display the data on the display device and (2) when the first resolution data information and the second resolution data information indicate a dysfunctional compatibility, the reproduction apparatus can activate the converting unit to convert the encoded data read by the reading unit into a data format having a compatible display resolution.

An encoded data detector unit can poll the control data to detect the resolution of the encoded data. If the control data does not contain a resolution value, a default resolution value can be entered in the second memory unit.

The reproduction apparatus can provide a stored menu data for displaying a menu to enable a user to select a resolution for storing in the first memory unit.

A machine readable information storage medium can be provided with encoded data for display on a display device including a data area for storing a plurality of objects, the objects further comprising motion picture data, sub-picture data and control data for controlling reproduction of the motion picture data and sub-picture data including management data for setting a resolution value of the motion picture data during reproduction.

The reproduction apparatus can poll for any resolution value in the management data of the storage medium and if none are found, can automatically set a default resolution value for reproduction purposes.

### BRIEF DESCRIPTION OF THE DRAWINGS

The exact nature of this invention, as well as its objects and advantages, will be readily appreciated upon reference to the following detailed description when considered in conjunction with the accompanying drawings, in which like reference numerals designate like parts throughout the figures thereof, and wherein:

FIG. 1 is a perspective view of a reproduction apparatus used in accordance with a preferred embodiment of the present invention;

FIG. 2 is a block diagram showing the construction of the reproduction apparatus formed in accordance with a preferred embodiment of the present invention;

FIG. 3 is a block diagram illustrating the resolution conversion process performed by a preferred embodiment of the reproduction apparatus of the present invention; and

FIG. 4 is an example illustrating the conversion of the HTML content description in accordance with the present invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the intention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide an apparatus and method for reproducing multimedia content in an undistorted manner at a variety of possible resolutions.

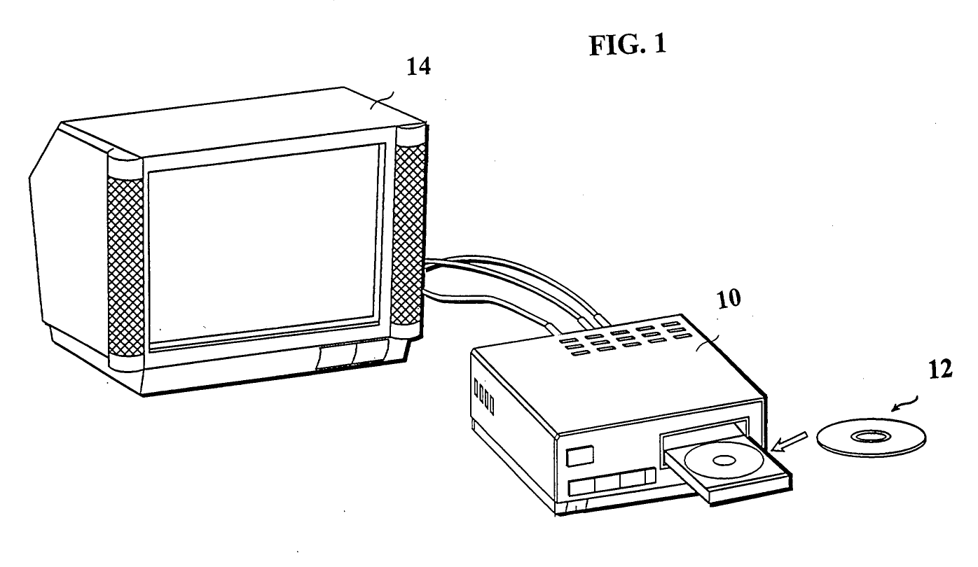

Referring now to FIG. 1, the multimedia environment for reproducing multimedia content in accordance with the present invention is illustrated, with a reproduction apparatus 10 (hereinafter referred to as “optical disc player 10”) being the central component. The optical disc player 10 reads multimedia content stored on an optical disc 12 and reproduces such content for display on a display device 14 connected to the optical disc player 10. Background examples of disc players and optical discs can be found in U.S. Pat. No. 6,393,202 and U.S. Pat. No. 6,389,221 incorporated herein by reference. The display device 14 is preferably an HDTV or SDTV, but may also comprise televisions having other resolutions or other types of display devices.

Multimedia content is often stored and distributed on an optical disc, such as a compact disc (CD), digital video disc (DVD), or next-generation DVDs making use of blue laser wavelengths. The present invention is directed to a method and apparatus for reproducing the information stored on such optical discs for display on a plurality of possible resolution display devices. While the present invention will be described primarily with reference to multimedia content stored on optical discs, it is understood that the multimedia content may be retrieved from any possible storage medium or be received from any source including but not limited to a broadcast transmission. Furthermore, for ease of discussion, the present invention will primarily be described with reference to content which is stored in either HDTV or SDTV format on an optical disc and converted for respectively being displayed on either SDTV or HDTV displays. However, it is the intention of the inventors of the present invention that the content being reproduced may be stored using any possible encoding format and displayed at any possible resolution.

The multimedia content stored on the optical disc 12 is encoded and recorded on the optical disc 12 according to a compression format associated with the resolution of the stored multimedia content. By way of example, almost all DVDs currently being manufactured contain multimedia content encoded and stored in standard resolution (SD) format for display on a SDTV. Conventionally, the DVDs or other storage mediums only contain the multimedia content encoded according to its associated format, but do not further contain resolution information about the stored content. The optical disc 12 of the present invention includes a storage area containing resolution information about the resolution of the multimedia content stored on the optical disc 12. The optical disc player 10 reads the multimedia content to be reproduced and its associated resolution information from the optical disc 12 and converts the read data from its stored resolution to a desired display resolution. The multimedia content may also be stored on memory cards or the like and inserted into a slot or drive 13 for retrieval by the optical disc player 10.

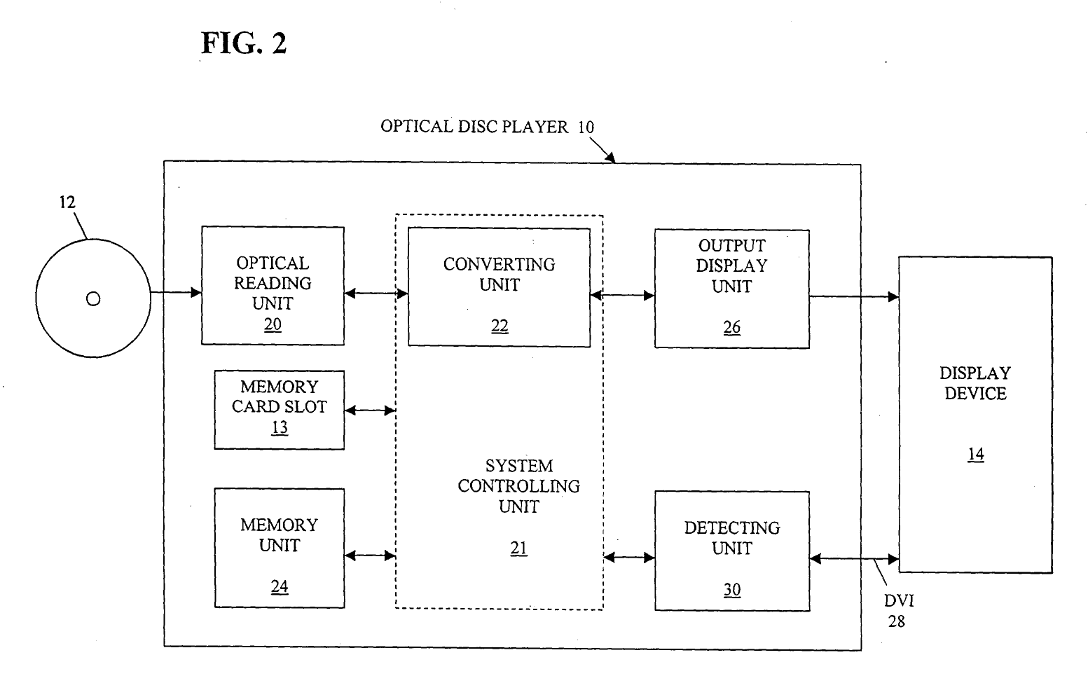

With reference to FIG. 2, the components of the optical disc player 10 are illustrated in block diagram format. The optical disc player 10 includes an optical reading unit 20 comprising a disc drive and optical pickup for reading information stored on the optical disc 12. The information read from the optical disc 12 includes content to be reproduced by the optical disc player 10 for display on the display device 14 as well as resolution information about the resolution of the content being reproduced. The content is generally encoded data including a plurality of objects, the objects further including motion picture data, sub-picture data and control data. The control data can further include information on the encoded data resolution of the motion picture data.

A system controlling unit 21 is provided for controlling the operations of each of the components of the optical disc player 10. The system controlling unit 21 is composed of a program memory for storing programs to realize functions of the system controlling unit 21, a work memory required for the program execution, a buffer memory for storing the content read from the optical disc 12, a CPU for executing the programs, and an interface controlling unit for inputting and outputting the data and control signals. With this construction, the system controlling unit 21 controls the entire optical disc player 10.

The read information is provided to a converting unit 22 which converts the content to be displayed from its stored resolution to a desired display resolution. After the data is converted from its stored resolution to the desired resolution, the converted data is then provided to an output display unit 26 for outputting the converted data to the attached display device 14 for display at the desired resolution.

The desired display resolution is preferably stored in a memory unit 24 and retrieved by the converting unit 22 prior to performing the desired resolution conversion. The desired display resolution may be predetermined and fixed in the memory unit 24 or may be variably selected and input by a user from an input device, such as a remote control unit or selectable controls on the optical disc player 10. For example, stored menu data can be displayed as a table or menu to enable a user to select a resolution for storing in a memory for processing the encoded data. In an alternative embodiment of the present invention, an interface 28 such as an digital video interface (DVI) may be provided between the optical disc player 10 and the display device 14 allowing bi-directional communication between the optical disc player 10 and the display device 14. In this alternative embodiment, a detecting unit 30 is connected to the interface 28 for detecting the resolution of the attached display device 14. The detected resolution is then stored by the detecting unit 30 into the memory unit 24 for use as the desired display resolution. Default values can be stored in the reproduction apparatus and used if no resolution data is detected or selected. The default values can be different from a disc type. For example, the default resolution of VideoCD is 352×240, one of DVD is 720×480, and one of Blu-Ray is 1920×1080. Such default values could be set to a conventional resolution or a high-resolution based on the disc (media) type that is detected or selected.

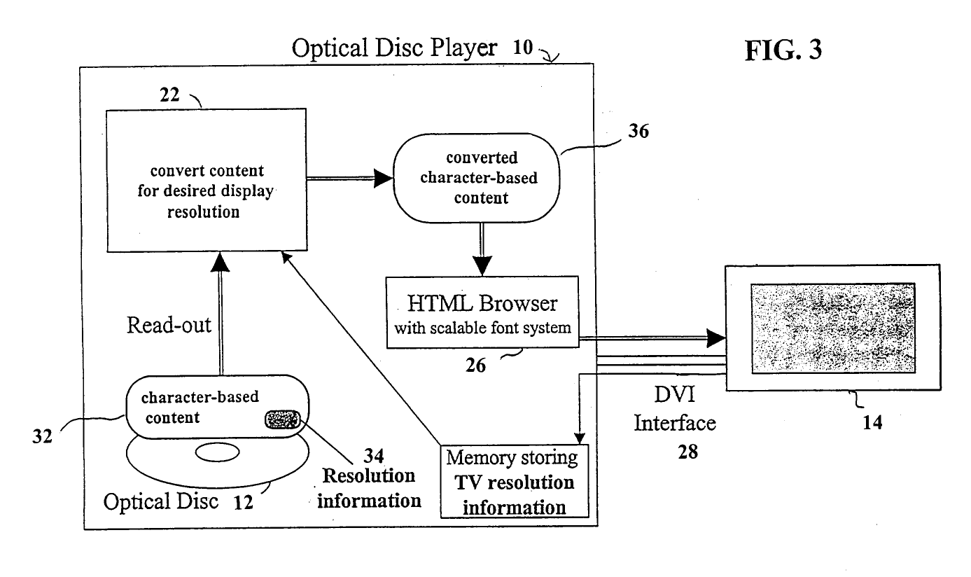

Referring now to FIG. 3, an operational block diagram illustrates the process performed by the optical disc player 10 in converting the content from its stored resolution on the optical disc 12 to the desired display resolution. Initially, information is read-out of the optical disc 12, wherein such information contains content 32 to be reproduced and its associated resolution information 34 describing the stored resolution of the content 32. The preferred embodiment of the present invention is particularly directed to content including character-based data such as HTML data including text, as it is a primary objective of the present invention to reproduce such text at a multitude of resolutions in an undistorted manner. The converting unit 22 reads the desired resolution to display the HTML content 32 from the memory unit 24, which may have been fixed, user selected, or detected through the DVI connection 28. The converting unit 22 then recalculates the contents of the HTML content 32 using a ratio of the desired resolution to the stored resolution, and outputs the converted HTML content 36. The converted HTML content 36 is then processed by the output display unit 26 and output at the desired resolution to the attached display device 14, wherein the output display unit 26 preferably comprises an HTML browser having a scalable font system.

Example of HTML Conversion from SD to HD

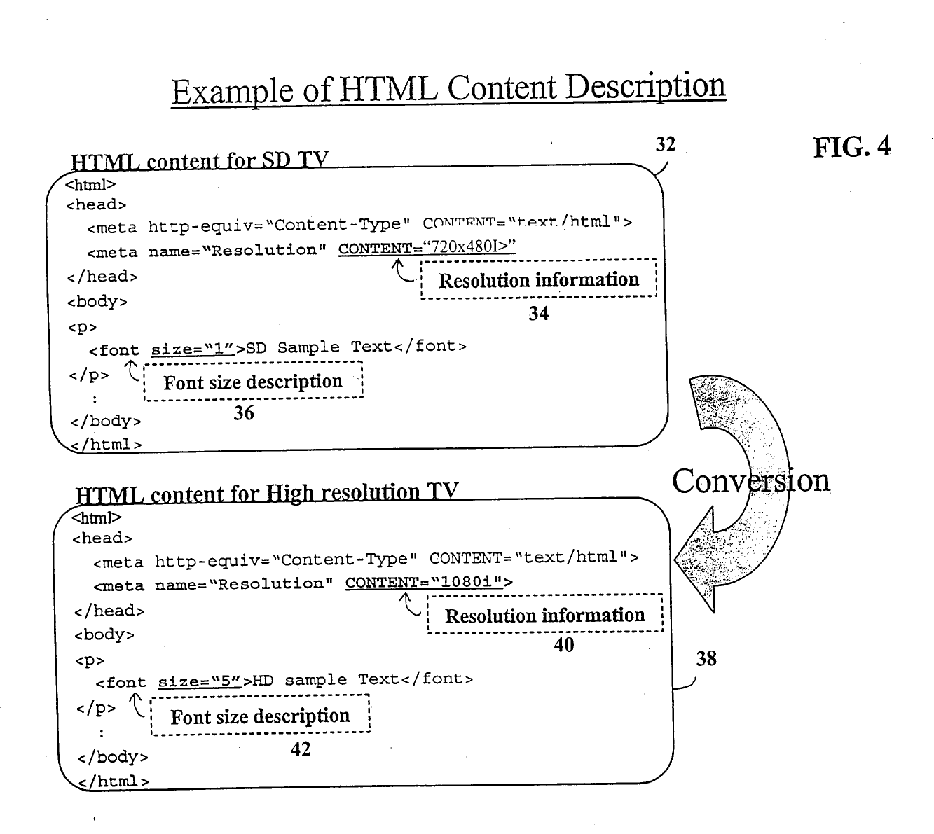

In order to illustrate the conversion process which takes place to the HTML content during the resolution conversion, the following example details a conversion of HTML content from standard definition (SD) resolution to high definition (HD) resolution, with reference to FIG. 4. The typical resolution in number of pixels of a SDTV is 720×480, while the typical resolution of a HDTV is 1920×1080. As such, the resolution information 34 stored with the HTML content 32 to describe the resolution of the HTML content for SDTV is:

<meta name=“Resolution” CONTENT=“720×480i”>

Meanwhile, it can be seen from the example in FIG. 4 that the HTML content 32 includes the following font size description 36 for the SD text:

<font size=“1”>

The conversion process needs to convert this SD content to a HD resolution for display on the HDTV. The desired resolution of 1920 vertical pixels and 1080 horizontal pixels for the HDTV is retrieved from the memory unit 24. Based on the ratio of the desired vertical resolution (1920 pixels) to the stored vertical resolution (720 pixels) as well as the ratio of the desired horizontal resolution (1080 pixels) to the stored horizontal resolution (480 pixels), the converting unit 22 computes that the font size description should be modified to a font size=“5” to accomplish the conversion to the desired resolution for the HTML content. The HTML content is then modified to a converted HTML content 36 having a revised resolution information 40 and revised font size description 42. The HTML browser 26 would then process the converted HTML content 38 to reproduce the content at the desired resolution for display on the attached HDTV.

The preceding example describes that the converting unit 22 performs the resolution conversion on the content to be reproduced by computing a ratio of the stored resolution to the desired resolution. More specifically, the converting unit 22 in a preferred embodiment of the present invention computes both a horizontal conversion ratio and a vertical conversion ratio of the stored-to-desired resolution. The horizontal conversion ratio is a ratio of the number of horizontal pixels in the desired resolution to the number of horizontal pixels in the stored resolution, while the vertical conversion ratio is a ratio of the number of vertical pixels in the desired resolution as compared to the number of vertical pixels in the stored resolution.

The following example illustrates the conversion of an image represented by HTML data from SD resolution to HD resolution. The examples described herein are merely provided for illustrating the teachings of the present invention and are not intended to limit the scope of the present invention to the particular examples. From these examples, it can be seen how the present invention allows content to be easily converted from a stored resolution to another desired display resolution without distorting the character-based content to be displayed.

First Example of Image Conversion from SD to HD Display

In order to convert an image from a stored SD resolution of 720×480 pixels to a desired display HD resolution of 1920×1080 pixels, the converting unit 22 calculates a horizontal ratio and a vertical ratio according to the following:

$$\begin{matrix}horizontal conversion ratio = \frac{( HD horizontal pixels )}{( SD horizontal pixels )} \\ = 1920 pixels / 720 pixels = 1.78\end{matrix}$$

$$\begin{matrix}vertical conversion ratio = \frac{( HD vertical pixels )}{( SD vertical pixels )} \\ = 1080 / 480 pixels = 2.25\end{matrix}$$

Based upon the horizontal and vertical conversion ratios, it is determined that the size of the image content must be increased horizontally by 178% and vertically by 225%. Thus, the converting unit 22 modifies the HTML content to produce converted HTML content according to the following:

[Example of HTML Description]

The following are an example of HTML conversion for above purpose.

The underlined tags are inserted to realize the conversion.

(Original HTML Data)

<img src=“../pictures/xxxxx.jpg”>

(Converted HTML Data)

<img src=“../pictures/xxxxx.jpg” height=178% width=225%>

Second Example of Image Conversion from SD to HD Display

In certain situations, multimedia content is originally generated having a resolution which is neither a conventional SD resolution nor a conventional HD resolution. Under conventional practice, this multimedia content would initially be required to be converted to a standard resolution format for encoding on an optical disc with other multimedia content designed for SD display. In order to then display this content on a HD display, the multimedia content would then need to be converted from the stored SD resolution to the desired HD display resolution. In this manner, the original multimedia content undergoes two resolution conversions under conventional practice, resulting in the loss of data and necessarily reducing the quality of the reproduced content. With the teachings of the present invention, only one conversion is required which greatly increases the quality of the reproduction. The following example illustrates an example of both the conventional practice requiring two conversions on the practice of the present invention requiring only a single conversion:

In the following example, an image is originally generated according to JFIF (JPEG File Interchange Format) and is to be reproduced for HD display. JFIF format is commonly used for digital still cameras to store the JPEG compressed image into a memory card. JFIF consists of several data segments and each segment has marker information to specify what kind of marker it is. For instance, 0×FF represents the start of marker and following one byte shows the type of marker. There are several segments like “application type0 segment”, “start of frame type 0 segment”, etc. The image width and image height are written in “Image_Width” and “Image_Height” fields within the “Start of frame type 0 segment” respectively.

JFIF format

Start of image Segment(0xFF, 0xD8)
. . .
Start of frame type 0(0xFF, 0xC0)
Field Length
Sample
Image_Height
Image_Width
. . .
End of image Segment

Conventionally, the JFIF image is originally converted to SD resolution. For the image conversion to SD display:

Horizontal conversion ration=720/Image_Width

Vertical conversion ration=480/Image_Height

Conventional practice of image conversion to HD display is then:

Horizontal conversion ration=1920/(720/Image_Width)

Vertical conversion ratio=1080/(480/Image_Height)

As can be seen from the conventional conversion practice, the image is converted to SD resolution first, then such SD resolution image is converted to the desired HD resolution display. Thus, conversion errors from converting to SD and then again converting to HD are accumulated and cause a loss in the quality of the image.

To the contrary, the practice of the present invention only performs one image conversion to HD resolution when the detecting unit detects an attached HD display. The system controlling unit will then convert the image as:

Horizontal conversion ration=1920/Image_Width

Vertical conversion ration=1080/Image_Height

Thus, the only conversion error occurs from a single conversion to HD only. Furthermore, when the original image has a greater resolution than a standard resolution display, content from the original image is lost when down-converted to the standard resolution. This loss of content is avoided by the technique of the present invention of converting only to the desired display resolution, and thus a more accurate image than previous practice can be obtained.

Square Pixel Resolution

When the content to be reproduced is character-based content, such as HTML data containing text, the vertical conversion ratio is further modified in another preferred embodiment of the present invention to ensure that a square pixel resolution is produced for the converted content to prevent the character-based content from becoming rugged or distorted. This modification of the vertical conversion ratio is accomplished by changing the line height of the character-based data to provide a square pixel resolution. The following example illustrates the conversion of a HTML text from SD resolution to HD resolution.

Example of Text Conversion from SD to HD Display

In order to convert HTML text from a stored SD resolution of 720×480 pixels to a desired display HD resolution of 1920×1080 pixels, the converting unit 22 calculates a horizontal ratio and a vertical ratio according to the following:

$$\begin{matrix}horizontal conversion ratio = \frac{( HD horizontal pixels )}{( SD horizontal pixels )} \\ = 1920 pixels / 720 pixels = 1.78\end{matrix}$$

At this point, in order to create a square pixel resolution, the line height of the vertical resolution of the stored resolution is first modified using the same horizontal conversion ratio determined above. The line height of the stored vertical resolution is modified as follows:

$$\begin{matrix} \begin{matrix}( modified stored \\ vertical resolution )\end{matrix} = \begin{matrix}stored vertical resolution * \\ horizontal conversion ratio\end{matrix} \\ = 480 pixels \times 1.78 \\ = 854.4 pixels\end{matrix}$$

After the line height has been modified to account for the square pixel resolution, the vertical conversion ratio is then computed as follows:

$$\begin{matrix}vertical conversion ratio = \frac{( HD vertical pixels )}{( modified SD vertical pixels )} \\ = 1080 / 854.4 pixels = 1.26\end{matrix}$$

Based upon the horizontal and vertical conversion ratios, it is determined that the size of the image content must be increased horizontally by 178% and vertically by 126%. Thus, the converting unit 22 modifies the HTML content to produce converted HTML content according to the following:

[Example of HTML Description]

The followings are an example of HTML conversion for above purpose.

The underlined tags are inserted to realize the conversion.

(Original HTML Data)

<p><font size=“3”>
*Characters displayed on screen*
</font></p>
(Converted HTML Data)
<p><font size=“3”>
<span style=“font-size:178%; color: line-height: 126%”>
*Characters displayed on screen*
</span>
</font></p>

As can be seen, the present invention provides an apparatus and method for reproducing character-based content at a multitude of possible resolutions without distortion. In this manner, the reproduction apparatus of the present invention allows character-based content in either standard definition (SD) or high definition (HD) format to be read from a storage medium and appropriately converted for undistorted display at the desired resolution of an attached display device. Thus, even when content is stored on a storage medium in a SD format, the reproduction apparatus of the present invention allows this content to be converted to a HD quality display on an attached HDTV. Moreover, when the content is originally stored in an HD format, the reproduction apparatus of the present invention allows the HD character-based content to be displayed in an undistorted manner on a SDTV.

In each of the above embodiments, the different structures and associated methods of the reproduction apparatus of the present invention are described separately in each of the embodiments. However, it is the full intention of the inventors of the present invention that the separate aspects of each embodiment described herein may be combined with the other embodiments described herein. Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A reproduction apparatus for reproducing information stored on a storage medium for display on a display device, comprising:
a reading unit for reading information from a storage medium, said information including content to be reproduced for display on a display device with said content having a stored resolution;
a converting unit for converting said content from said stored resolution to a desired display resolution for display using a ratio of said stored resolution to said desired display resolution; and
an output unit for outputting said converted data for display by said display 10 device at said desired display resolution.

2. The reproduction apparatus of claim 1, further comprising a memory unit for storing said desired display resolution.

3. The reproduction apparatus of claim 2, wherein said desired display resolution is a resolution of a display device connected to said reproduction apparatus.

4. The reproduction apparatus of claim 3, further comprising a detecting unit for detecting the resolution of said display device and storing said resolution in said memory unit.

5. The reproduction apparatus of claim 4 further including an encoded data detector unit for polling said content to detect the resolution and storing the resolution in the memory unit.

6. The reproduction apparatus of claim 5 wherein the encoded data detector unit enters a default resolution value in the memory unit when said content does not contain a resolution value.

7. The reproduction apparatus of claim 2, further comprising an input device for inputting said desired display resolution.

8. The reproduction apparatus of claim 1, wherein said storage medium is an optical disc.

9. The reproduction apparatus of claim 1, wherein said storage medium is a memory card.

10. The reproduction apparatus of claim 1, wherein said content to be displayed includes character-based data, wherein said converting unit modifies a font size of the character-based data based on said ratio of said stored resolution to said display device resolution.

11. The reproduction apparatus of claim 10, wherein said character-based data is HTML data containing text.

12. The reproduction apparatus of claim 10, wherein said converting unit further modifies a line height of the character-based data to provide a square pixel resolution.

13. The reproduction apparatus of claim 1, wherein said converting unit performs said conversion using a computed horizontal conversion ratio and vertical conversion ratio, said horizontal conversion ratio being a ratio of the number of horizontal pixels in said display device resolution to the number of horizontal pixels in said stored resolution, said vertical conversion ratio being a ratio of the number of vertical pixels in said display device resolution to the number of vertical pixels in said stored resolution.

14. A method of reproducing information stored on a storage medium for display on a display device, comprising:
reading information from a storage medium, said information including content to be reproduced for display on a display device with said content having a stored resolution;
converting said content from said stored resolution to a desired resolution for display using a ratio of said stored resolution to said desired display resolution; and
outputting said converted data for display by a display device.

15. The method of claim 14, further comprising storing said desired display resolution into a memory unit.

16. The method of claim 15, further comprising:
detecting a resolution of a display device to be used for displaying said content; and
storing said detected resolution into said memory unit as said desired display resolution.

17. The method of claim 15, further comprising entering a default resolution value automatically in the memory unit when the information from the storage medium does not have a stored resolution.

18. The method of claim 15, further comprising inputting said desired display resolution into said memory unit through a user-selectable input device.

19. The method of claim 14, wherein said storage medium is an optical disc.

20. The method of claim 14, wherein said data to be displayed includes character-based data, wherein said converting step further includes modifying a font size of the character-based data based on said ratio of said stored resolution to said desired display resolution.

21. The method of claim 20, wherein said character-based data is HTML data containing text.

22. The method of claim 20, wherein said converting step further includes modifying a line height of the character-based data to provide a square pixel resolution.

23. The method of claim 14, wherein said converting step further includes computing both a horizontal conversion ratio and a vertical conversion ratio to be used in performing the conversion, said horizontal conversion ratio being a ratio of the number of horizontal pixels in said display device resolution to the number of horizontal pixels in said stored resolution, said vertical conversion ratio being a ratio of the number of vertical pixels in said display device resolution to the number of vertical pixels in said stored resolution.

24. A machine readable information storage medium having machine readable information, comprising:
a first area containing content to be reproduced for display on a display device; and
a second area containing resolution information about said content contained in said first area.

25. The machine readable information storage medium of claim 24, wherein said storage medium is an optical disc.

26. The machine readable information storage medium of claim 24, wherein said storage medium is a memory card.

27. The machine readable information storage medium of claim 21, wherein said content contained in said first area is character-based data and said resolution information contained in said second area is an associated font size of said character-based data.

28. A reproduction apparatus for reading information stored on a storage medium, comprising:
a reading unit for reading information from a storage medium, said information including resolution information about content stored on the storage medium; and
a memory unit for storing the resolution information read from the storage medium.

29. A reproduction apparatus for reproducing encoded data so that the encoded data is compatible for display on display devices having different resolution capabilities, the encoded data including a plurality of objects, the objects further comprising motion picture data, sub-picture data and control data, the control data including information on the encoded data resolution of the motion picture data, comprising:
a reading unit for inputting the encoded data;
a first memory unit for storing first resolution data information for a display device operatively connected to the reproduction apparatus and to be enabled to display objects from the reproduction apparatus;
a second memory unit for storing second resolution data information on the encoded data read by the reading unit;
a converting unit for converting the encoded data read by the reading unit into a second data format having a compatible display resolution for the resolution data information stored in the first memory unit; and
a controller unit for comparing the first resolution data information with the second resolution data information and (1) when the first resolution data information and the second resolution data information indicate a functional compatibility proceeding to decode and display the data on the display device and (2) when the first resolution data information and the second resolution data information indicate a dysfunctional compatibility, activating the converting unit to convert the encoded data read by the reading unit into a data format having a compatible display resolution.

30. The reproduction apparatus of claim 29 further including a detecting unit for automatically detecting the resolution of the display device and storing the resolution in the first memory unit.

31. The reproduction apparatus of claim 29 further including an encoded data detector unit for polling the control data of the encoded data to detect the resolution of the encoded data and storing the resolution in the second memory unit.

32. The reproduction apparatus of claim 31 wherein the encoded data detector unit enters a default resolution value in the second memory unit when the control data does not contain a resolution value.

33. The reproduction apparatus of claim 29 further including a stored menu data for displaying a menu to enable a user to select a resolution for storing in the first memory unit.

34. A machine readable information storage medium including encoded data for display on a display device comprising a data area for storing a plurality of objects, the objects further comprising motion picture data, sub-picture data and control data for controlling reproduction of the motion picture data and sub-picture data including management data for setting a resolution value of the motion picture data during reproduction.
